(19) United States
(12) Patent Application Publication
(10) Pub. No.: US 2007/0250825 A1
(43) Pub. Date: Oct. 25, 2007

(54) Compiling Alternative Source Code Based on a Metafunction

(76) Inventors: Daniel Rodman Hicks, Byron, MN (US); Mark Douglas Schroeder, Rochester, MN (US)

Correspondence Address: IBM CORPORATION;ROCHESTER IP LAW DEPT. 917, 3605 HIGHWAY 52 NORTH, ROCHESTER, MN, 55901-7829, US

(21) Appl. No.: 11/379,616

(22) Filed: Apr. 21, 2006

(51) Int. Cl. G06F 9/45

(52) U.S. Cl. 717/151

(57) ABSTRACT

In an embodiment, a function call in source code is replaced inline with a body of the function. The body of the function includes a call to a metafunction, first alternative source code, and second alternative source code. The metafunction is evaluated to determine whether a compile-time environment attribute is true. If the compile-time environment attribute is true, the first alternative source code is compiled into object code, where the first alternative source code relies on truth of the compile-time environment attribute. If the compile-time environment attribute is false, the second alternative source code is compiled into the object code, where the second alternative source code does not rely on the truth of the compile-time environment attribute. For example, in an embodiment, the first alternative source code accesses an argument via an address of the argument while the second alternative source code copies the argument to a temporary variable and accesses the argument via the temporary variable. In this way, generated object code may be specialized based on a compile-time environment attribute.

### FIELD

An embodiment of the invention generally relates to computers. In particular, an embodiment of the invention generally relates to a compiler that compiles alternative source code based on a compile time attribute determined by a metafunction.

### BACKGROUND

The development of the EDVAC computer system of 1948 is often cited as the beginning of the computer era. Since that time, computer systems have evolved into extremely sophisticated devices, and computer systems may be found in many different settings. Computer systems typically include a combination of hardware, such as semiconductors and circuit boards, and software, also known as computer programs. Human programmers often write computer programs in a form of computer language that is relatively easy for a human to understand, but which is not efficient for the computer the execute. Another program, such as a compiler or interpreter, then transforms the program into a form that is more efficient for the computer to execute, but relatively difficult for a human to understand.

Recently, Java became a prominent computer language with a wide application spectrum, from embedded systems to enterprise servers. A Java Virtual Machine (JVM) is a software layer that interprets and executes Java bytecodes. One of the major issues in using the Java programming language, or any interpreted language, is performance.

Unfortunately, a standard Java Virtual Machine does not typically yield high-performing programs. In order to increase performance, a technique called just-in-time (JIT) compilation is sometimes used to execute Java code inside the Java Virtual Machine. Through just-in-time compilation, a Java bytecode method is dynamically translated into a native method (code native to the computer on which the program is executing) as the method executes, so as to remove the interpretation overhead of a typical Java Virtual Machine implementation. Since the just-in-time compilation itself is part of the total execution time of a Java program, in order to be useful the compilation must be fast, and the benefit from compilation must outweigh the just-in-time compilation overhead. Consequently, the implementation of a Java Virtual Machine with a just-in-time compiler requires many design choices in order to optimize performance of the executing program.

One such design choice involves providing fundamental algorithms in the compiler, which are often used intensively by applications. One example of such a fundamental algorithm is the Java string class, which is used to represent strings of characters. (Unlike some other computer languages, Java does not use an array of characters to represent a string.) The string class includes functions such as concatenation, converting the string to uppercase, converting the string to lowercase, returning the length of a string, trimming leading or trailing spaces, and replacing occurrences of one character with another character. Since these fundamental algorithms are used so intensively, producing high-performance code for them is important. For this reason, these fundamental algorithms are often not written in the compiler's language and compiled as normal functions; instead, the compiler produces code for them using embedded routines. This allows the fundamental algorithms to be specialized by the author of the compiler via design choices in various ways, such as by using knowledge that a particular parameter is a literal, i.e., its value is known at compile time and does not change at run time.

Unfortunately, this approach is labor-intensive and error-prone, and frequently suffers from being unable to recognize and properly specialize minor variations. This is especially a problem with a language like Java where new versions (with new fundamental algorithms and new variations on old algorithms) are frequently released.

Hence, what is needed is an enhanced compiler technique for specializing the generated object code based on a compile-time environment attribute.

### SUMMARY

A method, apparatus, system, and signal-bearing medium are provided. In an embodiment, a function call in source code is replaced inline with a body of the function. The body of the function includes a call to a metafunction, first alternative source code, and second alternative source code. The metafunction is evaluated to determine whether a compile-time environment attribute is true. If the compile-time environment attribute is true, the first alternative source code is compiled into object code, where the first alternative source code relies on truth of the compile-time environment attribute. If the compile-time environment attribute is false, the second alternative source code is compiled into the object code, where the second alternative source code does not rely on the truth of the compile-time environment attribute. For example, in an embodiment, the first alternative source code accesses an argument via an address of the argument while the second alternative source code copies the argument to a temporary variable and accesses the argument via the temporary variable. In this way, generated object code may be specialized based on a compile-time environment attribute.

### BRIEF DESCRIPTION OF THE DRAWING

FIG. 1 depicts a block diagram of an example system for implementing an embodiment of the invention.

FIG. 2 depicts a block diagram of example source code that invokes a function capable of being inlined, according to an embodiment of the invention.

FIG. 3 depicts a block diagram of an example function that is capable of being inlined, according to an embodiment of the invention.

FIG. 4 depicts a block diagram of the example source code after the example function has been inlined, according to an embodiment of the invention.

FIG. 5 depicts a flowchart of example processing for a compiler, according to an embodiment of the invention.

FIG. 6 depicts a flowchart of further example processing for the compiler, according to an embodiment of the invention.

### DETAILED DESCRIPTION

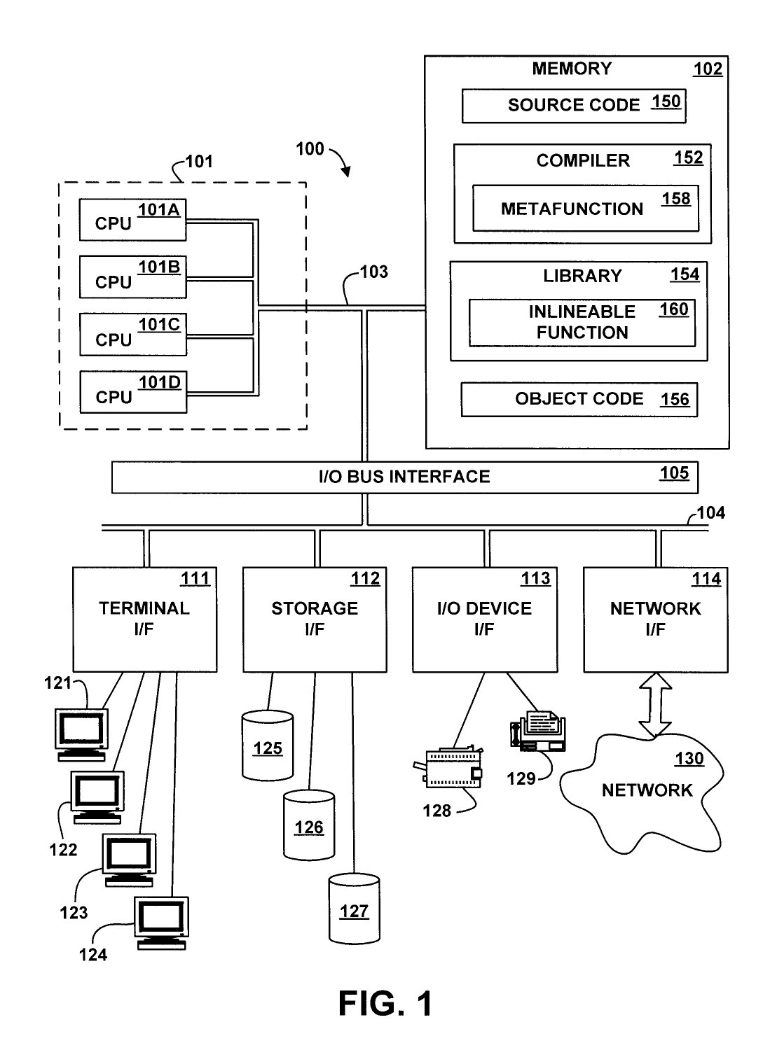

Referring to the Drawings, wherein like numbers denote like parts throughout the several views, FIG. 1 depicts a high-level block diagram representation of a computer system 100 connected to a network 130, according to an embodiment of the present invention. The major components of the computer system 100 include one or more processors 101, a main memory 102, a terminal interface 111, a storage interface 112, an I/O (Input/Output) device interface 113, and communications/network interfaces 114, all of which are coupled for inter-component communication via a memory bus 103, an I/O bus 104, and an I/O bus interface unit 105.

The computer system 100 contains one or more general-purpose programmable central processing units (CPUs) 101A, 101B, 101C, and 101D, herein generically referred to as the processor 101. In an embodiment, the computer system 100 contains multiple processors typical of a relatively large system; however, in another embodiment the computer system 100 may alternatively be a single CPU system. Each processor 101 executes instructions stored in the main memory 102 and may include one or more levels of on-board cache.

The main memory 102 is a random-access semiconductor memory for storing data and programs. The main memory 102 is conceptually a single monolithic entity, but in other embodiments, the main memory 102 is a more complex arrangement, such as a hierarchy of caches and other memory devices. For example, memory may exist in multiple levels of caches, and these caches may be further divided by function, so that one cache holds instructions while another holds non-instruction data, which is used by the processor or processors. Memory may further be distributed and associated with different CPUs or sets of CPUs, as is known in any of various so-called non-uniform memory access (NUMA) computer architectures.

The memory 102 includes source code 150, a compiler 152, a library 154, and object code 156. Although the source code 150, the compiler 152, the library 154, and the object code 156 are illustrated as being contained within the memory 102 in the computer system 100, in other embodiments some or all of them may be on different computer systems and may be accessed remotely, e.g., via the network 130. The computer system 100 may use virtual addressing mechanisms that allow the programs of the computer system 100 to behave as if they only have access to a large, single storage entity instead of access to multiple, smaller storage entities. Thus, while the source code 150, the compiler 152, the library 154, and the object code 156 are all illustrated as being contained within the memory 102 in the computer system 100, these elements are not necessarily all completely contained in the same storage device at the same time. Further, although the source code 150, the compiler 152, the library 154, and the object code 156 are illustrated as being separate entities, in other embodiments some of them, portions of some of them, or all of them may be packaged together.

The source code 150 includes human-readable statements, Java bytecodes, or other machine-generated intermediate representation of a computer program capable of being read by the compiler 152 and converted or translated into the object code 156. The library 154 includes an inlineable function 160, which is source code that the compiler 152 may inline or insert into the source code 150. In various embodiments, the inlineable function 160 may be a string function, a mathematical function, or any other type of function capable of being inlined into the source code 150.

Inlining the function 160 is a technique that is different from calling the function 160. When a function is called, the calling function or method temporarily ceases executing, the state of the calling function plus any arguments to be passed to the called function are saved, e.g., on an invocation stack, the called function gains control (e.g., in a different process or thread) and starts executing, and the called function retrieves any passed arguments from the invocation stack and substitutes them for its specified parameters at runtime. Once the called function is done executing, the thread or process of the called function closes, the state of the called function is restored from the invocation stack, and the calling function resumes executing. In contrast to a call or invocation, the body of an inlined function is inserted into the calling function and the arguments are substituted for the parameters at compile time. Hence, at runtime, the calling function and the inlined function are part of the same process or thread, which continues to execute when the body of the inlined function is encountered.

The object code 156 includes instructions capable of executing on the processor 101. The compiler 152 creates the object code 156 by compiling the source code 150 and the inlineable function 160.

The compiler 152 includes a metafunction 158. The metafunction 158 is called by the inlineable function 160, and when evaluated by the compiler 152 determines whether a compile-time environment attribute of the source code 150 being compiled is true or exists. In various embodiments, the metafunction 158 may determine whether a compile-time environment attribute is true or exists by determining whether an argument is invariant, whether an argument of a mathematical function is a literal, or by determining any other appropriate attribute of the source code 150 being compiled. The metafunction 158 is different from an ordinary function in that the metafunction 160 determines attributes related to the compile-time environment of the source code 150 rather than simply evaluating values within the source code 150. Thus, the metafunction 158 makes the source code 150 self aware of its environment.

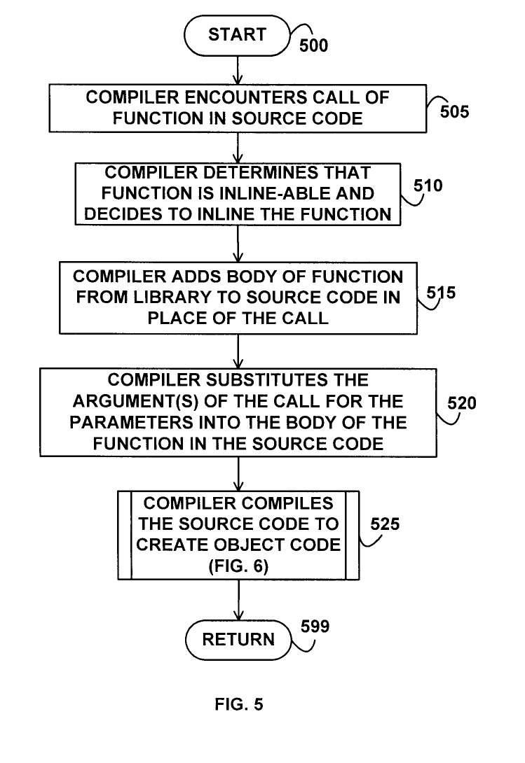

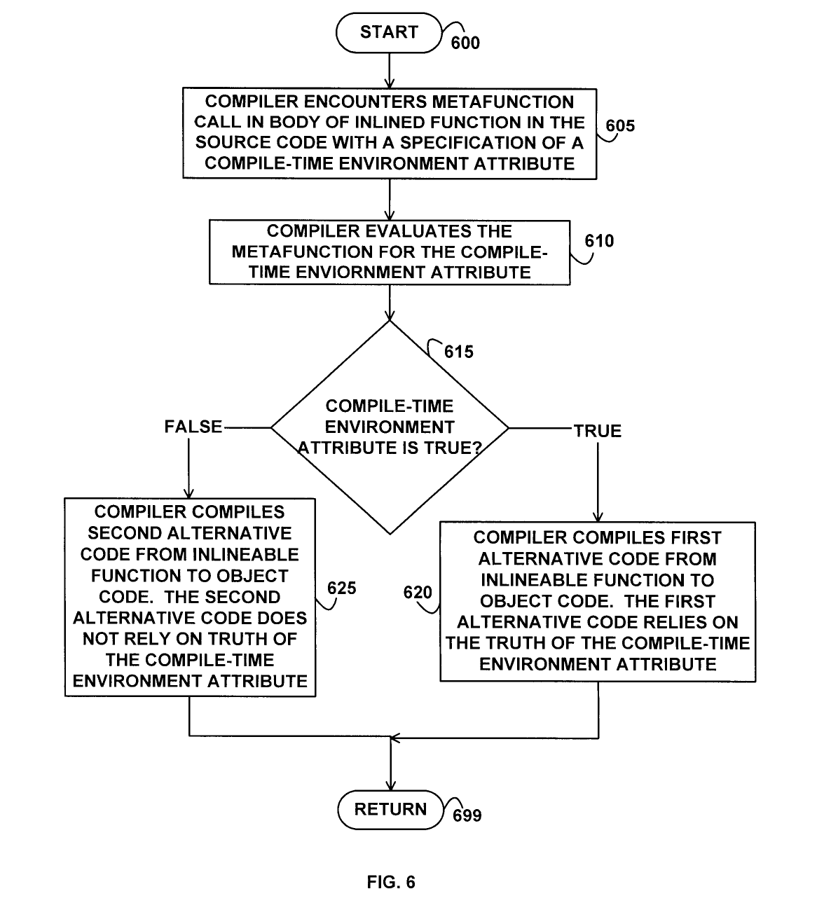

In an embodiment, the compiler 152 also includes instructions capable of executing on the processor 101 or statements capable of being interpreted by instructions executing on the processor 101 to perform the functions as further described below with reference to FIGS. 5 and 6. In another embodiment, the compiler 152 may be implemented in microcode. In another embodiment, the compiler 152 may be implemented in hardware via logic gates and/or other appropriate hardware techniques in lieu of or in addition to a processor-based system.

The memory bus 103 provides a data communication path for transferring data among the processors 101, the main memory 102, and the I/O bus interface unit 105. The I/O bus interface unit 105 is further coupled to the system I/O bus 104 for transferring data to and from the various I/O units. The I/O bus interface unit 105 communicates with multiple I/O interface units 111, 112, 113, and 114, which are also known as I/O processors (IOPs) or I/O adapters (IOAs), through the system I/O bus 104. The system I/O bus 104 may be, e.g., an industry standard PCI (Peripheral Component Interconnect) bus, or any other appropriate bus technology. The I/O interface units support communication with a variety of storage and I/O devices. For example, the terminal interface unit 111 supports the attachment of one or more user terminals 121, 122, 123, and 124.

The storage interface unit 112 supports the attachment of one or more direct access storage devices (DASD) 125, 126, and 127, which are typically rotating magnetic disk drive storage devices, although they could alternatively be other devices, including arrays of disk drives configured to appear as a single large storage device to a host. The contents of the DASD 125, 126, and 127 may be loaded from and stored to the memory 102 as needed. The storage interface unit 112 may also support other types of devices, such as a diskette device, a tape device, an optical device, or any other type of storage device.

The I/O device interface 113 provides an interface to any of various other input/output devices or devices of other types. Two such devices, the printer 128 and the fax machine 129, are shown in the exemplary embodiment of FIG. 1, but in other embodiment many other such devices may exist, which may be of differing types.

The network interface 114 provides one or more communications paths from the computer system 100 to other digital devices and computer systems; such paths may include, e.g., one or more networks 130. In various embodiments, the network interface 114 may be implemented via a modem, a LAN (Local Area Network) card, a virtual LAN card, or any other appropriate network interface or combination of network interfaces.

Although the memory bus 103 is shown in FIG. 1 as a relatively simple, single bus structure providing a direct communication path among the processors 101, the main memory 102, and the I/O bus interface 105, in fact the memory bus 103 may comprise multiple different buses or communication paths, which may be arranged in any of various forms, such as point-to-point links in hierarchical, star or web configurations, multiple hierarchical buses, parallel and redundant paths, etc. Furthermore, while the I/O bus interface 105 and the I/O bus 104 are shown as single respective units, the computer system 100 may in fact contain multiple I/O bus interface units 105 and/or multiple I/O buses 104. While multiple I/O interface units are shown, which separate the system I/O bus 104 from various communications paths running to the various I/O devices, in other embodiments some or all of the I/O devices are connected directly to one or more system I/O buses.

The computer system 100 depicted in FIG. 1 has multiple attached terminals 121, 122, 123, and 124, such as might be typical of a multi-user “mainframe” computer system. Typically, in such a case the actual number of attached devices is greater than those shown in FIG. 1, although the present invention is not limited to systems of any particular size. The computer system 100 may alternatively be a single-user system, typically containing only a single user display and keyboard input, or might be a server or similar device which has little or no direct user interface, but receives requests from other computer systems (clients). In other embodiments, the computer system 100 may be implemented as a firewall, router, Internet Service Provider (ISP), personal computer, portable computer, laptop or notebook computer, PDA (Personal Digital Assistant), tablet computer, pocket computer, telephone, pager, automobile, teleconferencing system, appliance, or any other appropriate type of electronic device.

The network 130 may be any suitable network or combination of networks and may support any appropriate protocol suitable for communication of data and/or code to/from the computer system 100. In various embodiments, the network 130 may represent a storage device or a combination of storage devices, either connected directly or indirectly to the computer system 100. In an embodiment, the network 130 may support Infiniband. In another embodiment, the network 130 may support wireless communications. In another embodiment, the network 130 may support hard-wired communications, such as a telephone line or cable. In another embodiment, the network 130 may support the Ethernet IEEE (Institute of Electrical and Electronics Engineers) 802.3x specification. In another embodiment, the network 130 may be the Internet and may support IP (Internet Protocol). In another embodiment, the network 130 may be a local area network (LAN) or a wide area network (WAN). In another embodiment, the network 130 may be a hotspot service provider network. In another embodiment, the network 130 may be an intranet. In another embodiment, the network 130 may be a GPRS (General Packet Radio Service) network. In another embodiment, the network 130 may be a FRS (Family Radio Service) network. In another embodiment, the network 130 may be any appropriate cellular data network or cell-based radio network technology. In another embodiment, the network 130 may be an IEEE 802.11B wireless network. In still another embodiment, the network 130 may be any suitable network or combination of networks. Although one network 130 is shown, in other embodiments any number of networks (of the same or different types) may be present.

It should be understood that FIG. 1 is intended to depict the representative major components of the computer system 100 and the network 130 at a high level, that individual components may have greater complexity than represented in FIG. 1, that components other than, fewer than, or in addition to those shown in FIG. 1 may be present, and that the number, type, and configuration of such components may vary. Several particular examples of such additional complexity or additional variations are disclosed herein; it being understood that these are by way of example only and are not necessarily the only such variations.

The various software components illustrated in FIG. 1 and implementing various embodiments of the invention may be implemented in a number of manners, including using various computer software applications, routines, components, programs, objects, modules, data structures, etc., referred to hereinafter as “computer programs,” or simply “programs.” The computer programs typically comprise one or more instructions that are resident at various times in various memory and storage devices in the computer system 100, and that, when read and executed by one or more processors in the computer system 100, cause the computer system 100 to perform the steps necessary to execute steps or elements embodying the various aspects of an embodiment of the invention.

Moreover, while embodiments of the invention have and hereinafter will be described in the context of fully functioning computer systems, the various embodiments of the invention are capable of being distributed as a program product in a variety of forms, and the invention applies equally regardless of the particular type of signal-bearing medium used to actually carry out the distribution. The programs defining the functions of this embodiment may be delivered to the computer system 100 via a variety of tangible signal-bearing media that may be operatively or communicatively connected (directly or indirectly) to the processor 101. The signal-bearing media may include, but are not limited to:

(1) information permanently stored on a non-rewriteable storage medium, e.g., a read-only memory device attached to or within a computer system, such as a CD-ROM readable by a CD-ROM drive;

(2) alterable information stored on a rewriteable storage medium, e.g., a hard disk drive (e.g., DASD 125, 126, or 127), CD-RW, or diskette; or

(3) information conveyed to the computer system 100 by a communications medium, such as through a computer or a telephone network, e.g., the network 130.

Such tangible signal-bearing media, when encoded with or carrying computer-readable and executable instructions that direct the functions of the present invention, represent embodiments of the present invention.

Embodiments of the present invention may also be delivered as part of a service engagement with a client corporation, nonprofit organization, government entity, internal organizational structure, or the like. Aspects of these embodiments may include configuring a computer system to perform, and deploying software systems and web services that implement, some or all of the methods described herein. Aspects of these embodiments may also include analyzing the client company, creating recommendations responsive to the analysis, generating software to implement portions of the recommendations, integrating the software into existing processes and infrastructure, metering use of the methods and systems described herein, allocating expenses to users, and billing users for their use of these methods and systems.

In addition, various programs described hereinafter may be identified based upon the application for which they are implemented in a specific embodiment of the invention. But, any particular program nomenclature that follows is used merely for convenience, and thus embodiments of the invention should not be limited to use solely in any specific application identified and/or implied by such nomenclature.

The exemplary environments illustrated in FIG. 1 are not intended to limit the present invention. Indeed, other alternative hardware and/or software environments may be used without departing from the scope of the invention.

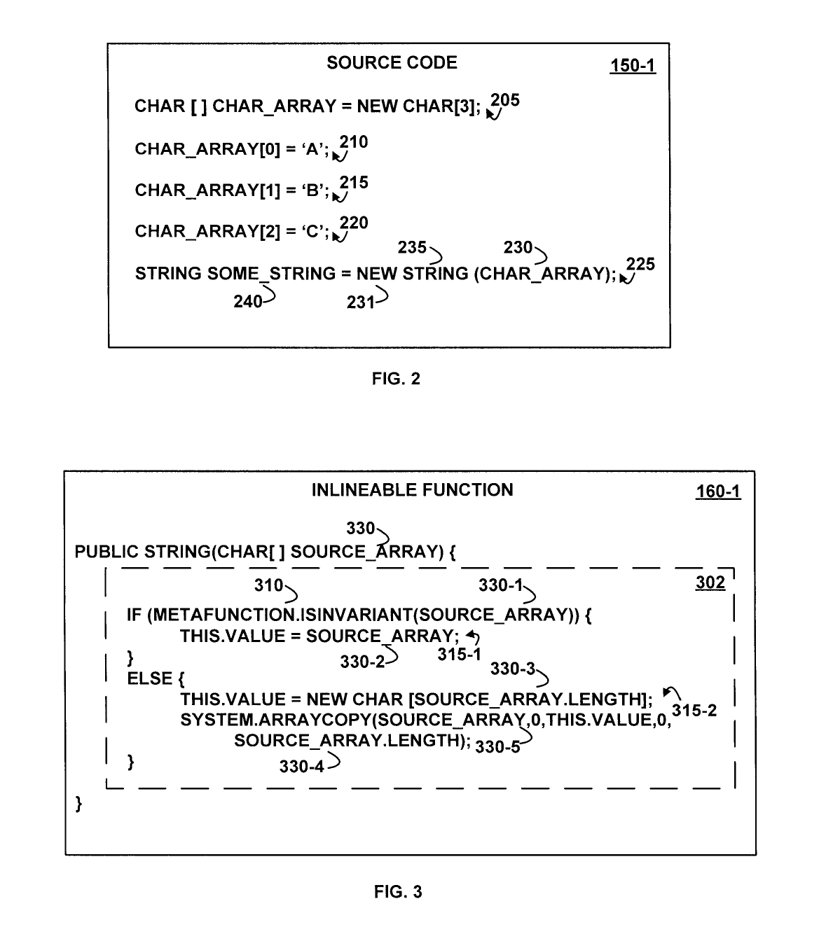

FIG. 2 depicts a block diagram of example source code 150-1 that invokes the inlineable function 160 (FIG. 1), according to an embodiment of the invention. The source code 150-1 is an example of the source code 150 (FIG. 1). The example source code 150-1 includes statements 205, 210, 215, 220, and 225. The statement 205 creates a character array with three elements. The assignment statements 210, 215, and 220 initialize the character array to “ABC,” and the call statement 225 passes an argument 230 of the character array via a call 235 (an invocation) of the inlineable function 160 (FIG. 1), which returns a string object that the statement 225 assigns to the string variable 240. The statement 225 includes a token 231 of “new,” which indicates to the compiler 152 that the call 235 is a special kind of method call known as a constructor. In response to the token 231, the compiler 152 allocates a new uninitialized instance of the string variable 240 before the call to the inlineable function 160 specified by the constructor method call 235.

Following the statement 225, the argument 230 (the character array in this example) is not modified by the source code 150-1, so the argument is said to be invariant. An invariant argument is an example of a compile-time environment attribute that is exists or is true, while an argument that is not invariant is an example of a compile-time environment attribute that does not exist or is false. Another example of a compile-time environment attribute, the truth or falsehood of which can be determined by the compiler 152, is whether or not an argument is a literal. A literal is a value that the compiler 152 knows at compile time and which does not change at run time.

Compile time is the time at which the compiler 152 compiles the source code 150 into the object code 156. Thus, a compile time environment attribute is a characteristic of which the compiler 152 can determine the truth of falsehood at the time of the compilation. In contrast to compile time, run time is the time of execution of the object code 156 (which was compiled from the source code 150) on the processor 101. Some environment attributes cannot be determined at compile time and must wait until run time because, e.g., they are dependent on the values of variables or data that are not known until execution of the object code 156 or because they are dependent on timing considerations between threads or processes.

FIG. 3 depicts a block diagram of an example function 160-1, according to an embodiment of the invention. The function 160-1 is an example of the inlineable function 160 and is capable of being inlined (having its body 302 inserted) into the source code 150-1 (FIG. 2). The example function 160-1 is passed a parameter 330. Instances 330-1, 330-2, 330-3, 330-4, and 330-5 of the parameter 330 are used in the body 302 of the inlineable function 160-1.

The body 302 of the inlineable function 160-1 further includes a metafunction call 310 (which calls the metafunction 158), first alternative source code 315-1, and second alternative source code 315-2. In another embodiment, the body 302 may include any number of alternative source code sections. If the function 160-1 is called or invoked by the source code 150-1, the function 160-1 is passed an argument (e.g., the argument 230 of FIG. 2) via the parameter 330, e.g. via an invocation stack. If the function 160-1 is inlined into the source code 150-1 in place of the call 235 (FIG. 2), then the compiler 152 replaces the instances 330-1, 330-2, 330-3, 330-4, and 330-5 of the parameter 330 with the argument 230, as further described below with reference to FIG. 5.

The first alternative source code 315-1 accesses the parameter instance 330-2 via an address of the parameter. In another embodiment, the first alternative source code 315 may return a literal result of a mathematical function. The second alternative source code 315-2 copies the parameter to a temporary variable (“this.value”) and accesses the parameter via the temporary variable. In another embodiment, the second alternative source code 315-2 may include a call to a mathematical function, and the call may pass the parameter to the mathematical function at run-time. In the example illustrated alternative source code 315-1 and 315-2, “this” is a symbolic token for the object being created that the function 160-1 returns as a result of its invocation, and “value” is a field within that object. This returned value is then set to the string variable 240 by operation of the statement 225 (FIG. 2).

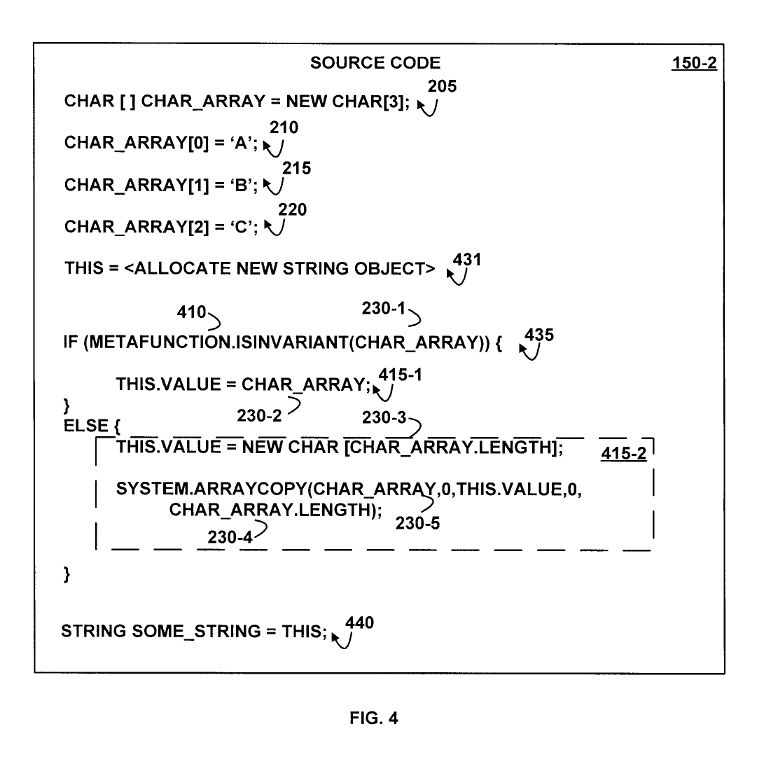

FIG. 4 depicts a block diagram of example source code 150-2 after the body 302 of the example function 160-1 (FIG. 3) has been inlined into the source code 150-1 (FIG. 2), according to an embodiment of the invention.

The source code 150-2 includes the same statements 205, 210, 215, and 220 as does the source code 150-2. But, the compiler 152 has replaced the statement 225 (FIG. 2) with the new object allocation operation 431 and the body 302 (FIG. 3) of the inlineable function 160-1 and has substituted the argument 230 (FIG. 2) for the instances 330-1, 330-2, 330-3, 330-4, and 330-5 of the parameter 330 to create the argument instances 230-1, 230-2, 230-3, 230-4, and 230-5, respectively. The source code 150-2 includes the metafunction call 410 corresponding to the metafunction call 310 of FIG. 3. The source code 150-2 further includes first and second alternative source code 415-1 and 415-2 corresponding to the first and second alternative source code 315-1 and 315-2, respectively, of FIG. 3.

The compiler 152 evaluates the metafunction call 410 using the argument 230-1 at compile time and if the metafunction call 410 evaluates to true, compiles the first alternative source code 415-1 into object code 156, but the second alternative source code 415-2 is not compiled into the object code 156. The compiler 152 further eliminates the “if” statement 435 from the resultant object code 156 (using techniques known to those skilled in the art) since the statement 435 has already been evaluated at compile time and so is not needed by the object code 156 at run time. The first alternative source code 415-1 relies on truth or existence of the compile-time environment attribute. For example, the first alternative source code 415-1 relies on the argument 230-2 not being changed because the first alternative source code 415-1 is accessing the argument 230-2 directly at its storage location, so if storage location of the argument 230-2 is changed (is not invariant), then first alternative source code 415-1 is creating a string that changes, and the definition of strings in Java requires them to not change.

If the metafunction call 410 evaluates to false, then the compiler 152 compiles the second alternative source code 415-2 into the object code 156, and the first alternative source code 415-1 is not compiled into the object code 156. As before, the compiler 152 further eliminates the “if” statement 435 from the resultant object code 156. The second alternative source code 415-2 does not rely on the truth or existence of the compile-time environment attribute or operates undependably of the truth or falsehood of the compile-time environment attribute. For example, the second alternative source code 415-2 will operate correctly (will keep the value of the argument 230-3 fixed and invariant) because the second alternative source code 415-2 makes a copy of the argument at statement 230-5, so if the storage location of the argument is subsequently modified, the string object created at statement 440 does not change because it is using a copy of the argument made prior to the change.

FIG. 5 depicts a flowchart of example processing for a compiler 152, according to an embodiment of the invention. Control begins at block 500. Control then continues to block 505 where the compiler 152 encounters the call of the function 160 in the source code 150, e.g., at the statement 225 in FIG. 2. Control then continues to block 510 where the compiler 152 determines that the function 160 is capable of being inlined in the source code 150, and the compiler 152 decides to inline the inlineable function 160.

Control then continues to block 515 where the compiler 152 adds the body 302 of the inlineable function 160 from the library 154 to the source code 150, replacing the call of a inlineable function 160 in the source code 150 with the body 302 of the inlineable function 160 inline in the source code 150, as illustrated in FIG. 3. The body 302 of the inlineable function 160 inlined into the source code 150 includes a call 410 to the metafunction 158, the first alternative source code 415-1, and the second alternative source code 415-2.

Control then continues to block 520 where the compiler 152 substitutes the argument or arguments of the call for the parameters into the body 302 of the inlineable function 160 that is inlined in the source code 150. Thus, the compiler 152 replaces a parameter in the body 302 of the inlineable function 160 with an argument of the call of the inlineable function 160, e.g., as argument instances 230-1, 230-2, 230-3, 230-4, and 230-5 in FIG. 4.

Control then continues to block 525 where the compiler 152 compiles the source code 150 with the inlined function 160 to create the object code 156, as further described below with reference to FIG. 6. Control then continues to block 599 where the logic of FIG. 5 returns.

FIG. 6 depicts a flowchart of further example processing for the compiler 152, according to an embodiment of the invention. Control begins at block 600. Control then continues to block 605 where the compiler 152 encounters the call 410 of the metafunction 158 in the body of the inlined function 160 in the source code 150. The call specifies the compile-time environment attribute, e.g., whether the argument is invariant or whether the argument is a literal. Control then continues to block 610 where the compiler 152 evaluates the metafunction 158 for the compile-time environment attribute to determine whether the compile-time environment attribute is true or exists. In various embodiments, the evaluating the metafunction 158 may include determining whether the argument is invariant or determining whether an argument of a mathematical function is a literal. An argument is invariant if it is not subsequently modified and does not escape, e.g., by having its address stored in another object. An argument is a literal if its value is known at compile time and does not change.

The metafunction 158 is failsafe, i.e., if the compiler 152 has insufficient information to determine whether the compile-time environment attribute is true or false, then the compiler 152 selects one value (e.g., “true” or “false”) as the failsafe value, and the inlineable function 160 that calls the metafunction 158 is constructed such that the failsafe value will cause valid (but perhaps not optimal) object code to be constructed. In an embodiment, the failsafe value is “false,” but in another embodiment the failsafe value is “true.” In another embodiment, the metafunction 158 may return an integer or any other multi-valued data type. Further, in other embodiments, the metafunction 158 may return any number of values with any number of corresponding alternative source code segments.

In an embodiment, the compiler 152 may perform any number of separate passes over the source code 150, with each pass performing a specific optimization. Since some of these passes can (via, e.g., constant propagation) make information available that was not previously known, a metafunction 158 with a failsafe value of “true” does not subsequently evaluate to “false,” but a metafunction 158 that evaluates to “false” in an early pass may subsequently evaluate to “true” in a later pass. Thus, the compiler 152 may reevaluate the metafunction 158 multiple times during the compilation. If the metafunction 158 ever evaluates as “true,” then the metafunction call is replaced by the literal “true,” which allows subsequent passes to eliminate the unused false leg (the second alternative source code 415-2) of the “if” statement 435 (FIG. 4). Prior to the last pass that could do such dead code elimination, the compiler 152 replaces all metafunctions that had not been successfully evaluated to “true” with the literal “false,” although some metafunctions might be so replaced sooner, once any opportunity for their evaluation to change had passed.

The advantage of this approach is that much of the logic used for algorithm customization can be pushed up into the source language versus being coded in the compiler 152 itself. This speeds implementation, reduces errors, and eliminates the need to link a specific version of the compiler 152 to a specific version of the source language algorithms. In addition, better performing code may be produced since the metafunctions 158 can be automatically reevaluated during multiple different passes in the compiler 152, whereas optimizations that are hard-coded into the compiler 152 generally only occur in a specific pass.

Control then continues to block 615 where the compiler 152 determines whether the compile-time environment attribute is true. If the determination at block 615 is true, then the compile-time environment attribute is true or exists, so control continues to block 620 where the compiler 152 compiles the first alternative source code 415-1 from the inlineable function 160 to the object code 156. The first alternative source code 415-1 relies on, depends upon, or uses the existence or truth of the compile-time environment attribute. The second alternative source code 415-2 and the “if statement” 435 are not compiled to the object code 156. Control then continues to block 699 where the logic of FIG. 6. returns.

If the determination at block 615 is false, then the compile-time environment attribute is false or does not exist, so control continues to block 625 where the compiler 152 compiles the second alternative source code 415-2 from the inlineable function 160 to the object code 156. The second alternative source code 415-2 does not rely on, is independent from, or does not use the existence or truth of the compile-time environment attribute. The first alternative source code 415-1 and the “if statement” 435 are not compiled to the object code 156. Control then continues to block 699 where the logic of FIG. 6. returns.

Although FIG. 6 only illustrates the compilation for the inlineable source code 160, the compiler 152 also compiles the source code 150 to the object code 156.

In the previous detailed description of exemplary embodiments of the invention, reference was made to the accompanying drawings (where like numbers represent like elements), which form a part hereof, and in which is shown by way of illustration specific exemplary embodiments in which the invention may be practiced. These embodiments were described in sufficient detail to enable those skilled in the art to practice the invention, but other embodiments may be utilized and logical, mechanical, electrical, and other changes may be made without departing from the scope of the present invention. Different instances of the word “embodiment” as used within this specification do not necessarily refer to the same embodiment, but they may. Any data and data structures illustrated or described herein are examples only, and in other embodiments, different amounts of data, types of data, fields, numbers and types of fields, field names, numbers and types of records, entries, or organizations of data may be used. In addition, any data may be combined with logic, so that a separate data structure is not necessary. The previous detailed description is, therefore, not to be taken in a limiting sense, and the scope of the present invention is defined only by the appended claims.

In the previous description, numerous specific details were set forth to provide a thorough understanding of the invention. But, the invention may be practiced without these specific details. In other instances, well-known circuits, structures, and techniques have not been shown in detail in order not to obscure the invention.

What is claimed is:

1. A method comprising:
replacing a call of a function in source code with a body of the function inline in the source code, wherein the body of the function comprises a call to a metafunction, first alternative source code, and second alternative source code;
evaluating the metafunction during compilation of the source code to determine whether a compile-time environment attribute of the source code is true; and
if the compile-time environment attribute is true, compiling the first alternative source code into object code, wherein the first alternative source code relies on truth of the compile-time environment attribute.

2. The method of claim 1, further comprising:
if the compile-time environment attribute is false, compiling the second alternative source code into the object code, wherein the second alternative source code does not rely on the truth of the compile-time environment attribute.

3. The method of claim 2, further comprising:
replacing a parameter in the body of the function with an argument of the call of the function.

4. The method of claim 3, wherein the evaluating the metafunction to determine whether a compile-time environment attribute is true further comprises:
determining whether the argument is invariant.

5. The method of claim 4, wherein the first alternative source code comprises:
accessing the argument via an address of the argument.

6. The method of claim 4, wherein the second alternative source code comprises:
copying the argument to a temporary variable; and
accessing the argument via the temporary variable.

7. The method of claim 2, wherein the function comprises a mathematical function.

8. The method of claim 7, wherein the evaluating the metafunction to determine whether a compile-time environment attribute is true further comprises:
determining whether an argument of the mathematical function is a literal.

9. The method of claim 8, wherein the first alternative source code comprises a literal result of the mathematical function.

10. The method of claim 8, wherein the second alternative source code comprises a call to the mathematical function, wherein the call passes the argument to the mathematical function at run-time.

11. A signal-bearing medium encoded with instructions, wherein the instructions when executed comprise:
replacing a call of a function in source code with a body of the function inline in the source code, wherein the body of the function comprises a call to a metafunction, first alternative source code, and second alternative source code;
evaluating the metafunction during compilation of the source code to determine whether a compile-time environment attribute of the source code is true;
if the compile-time environment attribute is true, compiling the first alternative source code into object code, wherein the first alternative source code relies on truth of the compile-time environment attribute; and
if the compile-time environment attribute is false, compiling the second alternative source code into the object code, wherein the second alternative source code does not rely on the truth of the compile-time environment attribute.

12. The signal-bearing medium of claim 11, further comprising:
replacing a parameter in the body of the function with an argument of the call of the function, wherein the evaluating the metafunction to determine whether a compile-time environment attribute is true further comprises determining whether the argument is invariant.

13. The signal-bearing medium of claim 12, wherein the first alternative source code comprises accessing the argument via an address of the argument, and wherein the second alternative source code comprises copying the argument to a temporary variable and accessing the argument via the temporary variable.

14. The signal-bearing medium of claim 11, wherein the function comprises a mathematical function, and wherein the evaluating the metafunction to determine whether a compile-time environment attribute is true further comprises determining whether an argument of the mathematical function is a literal.

15. The signal-bearing medium of claim 14, wherein the first alternative source code comprises a literal result of the mathematical function, and wherein the second alternative source code comprises a call to the mathematical function, wherein the call passes the argument to the mathematical function at run-time.

16. A method for configuring a computer, comprising:
configuring the computer to replace a call of a function in source code with a body of the function inline in the source code, wherein the body of the function comprises a call to a metafunction, first alternative source code, and second alternative source code;
configuring the computer to evaluate the metafunction during compilation of the source code to determine whether a compile-time environment attribute of the source code is true;
configuring the computer to, if the compile-time environment attribute is true, compile the first alternative source code into object code, wherein the first alternative source code relies on truth of the compile-time environment attribute; and
configuring the computer to, if the compile-time environment attribute is false, compile the second alternative source code into the object code, wherein the second alternative source code does not rely on the truth of the compile-time environment attribute.

17. The method of claim 16, further comprising:
configuring the computer to replace a parameter in the body of the function with an argument of the call of the function, wherein the evaluating the metafunction to determine whether a compile-time environment attribute is true further comprises determining whether the argument is invariant.

18. The method of claim 17, wherein the first alternative source code comprises accessing the argument via an address of the argument, and wherein the second alternative source code comprises copying the argument to a temporary variable and accessing the argument via the temporary variable.

19. The method of claim 16, wherein the function comprises a mathematical function, and wherein the configuring the computer to evaluate the metafunction to determine whether a compile-time environment attribute is true further comprises configuring the computer to determine whether an argument of the mathematical function is a literal.

20. The method of claim 19, wherein the first alternative source code comprises a literal result of the mathematical function, and wherein the second alternative source code comprises a call to the mathematical function, wherein the call passes the argument to the mathematical function at run-time.
